(19) United States
(12) Patent Application Publication
(10) Pub. No.: US 2014/0223457 A1
(43) Pub. Date: Aug. 7, 2014

(54) OPTICAL DISK DRIVE INCLUDING SPINDLE UNIT AND CHUCKING STRUCTURE

(71) Applicant: Toshiba Samsung Storage Technology Korea Corporation, Suwon-si (KR)

(72) Inventors: Nam-kook BAEK, Suwon-si (KR); Seong-yeon Park, Suwon-si (KR)

(73) Assignee: Toshiba Samsung Storage Technology Korea Corporation, Suwon-si (KR)

(21) Appl. No.: 14/172,198

(22) Filed: Feb. 4, 2014

(30) Foreign Application Priority Data
Feb. 5, 2013 (KR) 10-2013-0013079

(51) Int. Cl. G11B 17/028

(52) U.S. Cl. CPC G11B 17/0284; G11B 17/0288
USPC 720/706

(57) ABSTRACT

Provided is a spindle unit. The spindle unit includes: a spindle motor having a rotation shaft; a turntable that is coupled to the rotation shaft and supports a data storage device; and a sliding cone coupled to the turntable so as to elastically move up and down and to be inserted into a hole formed at the data storage device. The sliding cone includes a bump protruding from a surface thereof, and the bump has a concave portion recessed downward from a center thereof.

### CROSS-REFERENCE TO RELATED PATENT APPLICATION

This application claims the benefit under 35 U.S.C. §119(a) of Korean Patent Application No. 10-2013-0013079, filed on Feb. 5, 2013, in the Korean Intellectual Property Office, the entire disclosure of which is incorporated herein by reference for all purposes.

### BACKGROUND

1. Field

The following description relates to a spindle unit for rotating an optical disc, a chucking structure for chucking the optical disc together with the spindle unit, and an optical disc drive including the chucking structure.

2. Description of Related Art

An optical disc drive typically includes a chucking structure for rotatably supporting and rotating a disc and an optical pickup unit for reading information from and/or writing information to the disc. The chucking structure may include a spindle unit on which the disc is mounted, and the spindle unit further includes a spindle motor for rotating the spindle unit and a clamper for fixing the disc onto the spindle unit.

The disc mounted on the spindle unit is chucked by the clamper. The chucking structure may be a magnetic chucking structure. In the magnetic chucking structure, a disc is disposed between the spindle unit and the clamper and chucked due to a magnetic attractive force acting between the spindle unit and the clamper. The clamper and the spindle unit may include a magnet and a yoke corresponding to the magnet, respectively. Alternatively, the clamper and the spindle may have a yoke and a magnet, respectively. However, because this conventional magnetic chucking structure causes noise when the spindle unit collides with the clamper for disc chucking, there have been long-felt needs for research to reduce chucking noise for quieter disc chucking operation. Furthermore, since a magnet is typically made of neodymium (Nd) which is an expensive rare-earth metal, the use of such an expensive metal may significantly increase manufacturing costs. Therefore, there is a need for a chucking structure configured to perform stable disc chucking and reduce the manufacturing costs.

### SUMMARY

In an aspect, there is provided a spindle unit comprising a spindle motor having a rotation shaft, a turntable that is coupled to the rotation shaft and supports a disc, and a sliding cone that is coupled to the turntable so as to elastically move up and down and is inserted into a hole formed at the disc. The sliding cone may include a bump protruding from a surface thereof, and the bump may have a concave portion recessed downward from a center thereof.

The concave portion may be aligned with the rotation shaft in a line.

The bump may have a diameter less than that of the surface of the sliding cone.

An extent to which the bump protrudes from the surface of the sliding cone may be 0.1 mm or more. The extent to which the bump protrudes from the surface of the sliding cone is 0.5 mm or more.

The turntable may further comprise at least one ball balancer which reduces vibrations.

The spindle unit may further comprise an elastic member interposed between the sliding cone and the turntable so as to elastically support the sliding cone.

In another aspect, there is provided a chucking structure comprising: a spindle unit comprising a spindle motor having a rotation shaft, a turntable that is coupled to the rotation shaft and supports a data storage device, and a sliding cone that is coupled to the turntable so as to elastically move up and down and is inserted into a hole formed at a disc, wherein the sliding cone includes a bump protruding from a surface thereof, and the bump has a concave portion recessed downward from a center thereof; and a clamper that is disposed to face the turntable and elastically support a surface of the data storage device. The clamper may comprise an insert protrusion configured to be inserted into the concave portion.

The concave portion may be aligned with the rotation shaft in a line.

The bump may have a diameter less than that of the top surface of the sliding cone.

The turntable may further comprise at least one ball balancer which reduces vibrations.

The spindle unit may further comprise an elastic member interposed between the sliding cone and the turntable so as to elastically support the sliding cone.

The spindle unit may further comprise a chucking spring for biasing the clamper toward the turntable.

In another respect, there is provided an optical disc drive comprising: a main frame; a tray which has an optical disc mounted thereon and is loaded/unloaded by sliding into/out of the main frame; a main base installed to move up and down with respect to the main frame in synchronization with loading/unloading of the tray; a spindle unit of mounted on the main base, the spindle unit comprising a spindle motor having a rotation shaft, a turntable that is coupled to the rotation shaft and supports the data storage device, and a sliding cone that is coupled to the turntable so as to elastically move up and down and is inserted into a hole formed at a disc, wherein the sliding cone includes a bump protruding from a surface thereof, and the bump has a concave portion recessed downward from a center thereof; an optical pickup unit mounted on the main base and corresponding to the optical disc, a cover covering an upper part of the main base, and a clamper that is disposed in the cover to face the turntable and elastically support a top surface of the optical disc and has an insert protrusion that is disposed at a center thereof and is inserted into the concave portion.

The spindle unit may further comprise an elastic member interposed between the sliding cone and the turntable so as to elastically support the sliding cone.

The tray may have first and second mounting surfaces on which discs having different sizes are mounted, respectively, and the second mounting surface may be recessed downward from the first mounting surface.

An extent to which the bump protrudes from the top surface of the sliding cone may be determined so that a distance between an edge of the bump and the bottom surface of the optical disc is 0.3 mm or more.

In another aspect, there is provided a disk apparatus comprising: a clamper comprising an insert protrusion on a surface of the clamper, and a rotational support on a surface of the clamper disposed to be concentric with the insert protrusion; and a chucking spring that is elastically movable up and down and is adapted to contact the rotational support.

The disk apparatus may further comprise a lubricating member disposed on a surface of the chucking spring and facing the clamper.

Centers of the insert protrusion, the rotational support, and the lubricating members may be arranged in a line.

Other features and aspects will be apparent from the following detailed description, the drawings, and the claims.

### BRIEF DESCRIPTION OF THE DRAWINGS

FIG. 1 is a diagram illustrating an example of a schematic exploded perspective view of an optical disc drive employing a chucking structure for an optical disc.

FIG. 2 is a diagram illustrating an example of a schematic exploded perspective view of a chucking structure.

FIG. 3 is a diagram illustrating an example of a cross-sectional view of a chucking structure.

FIG. 4 is a diagram illustrating an example of a cross-sectional view illustrating a state of a chucking structure when a tray is unloaded.

FIG. 5 is a diagram illustrating an example of a cross-sectional view illustrating a state of a chucking structure when a tray is being loaded;

FIG. 6 is a diagram illustrating an example of a cross-sectional view illustrating a state of a chucking structure after completing loading of a tray;

FIG. 7 is a diagram illustrating an example of a bump in a sliding cone; and

FIG. 8 is a diagram illustrating an example of a distance between a bump in a sliding cone and an optical disc.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE INVENTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

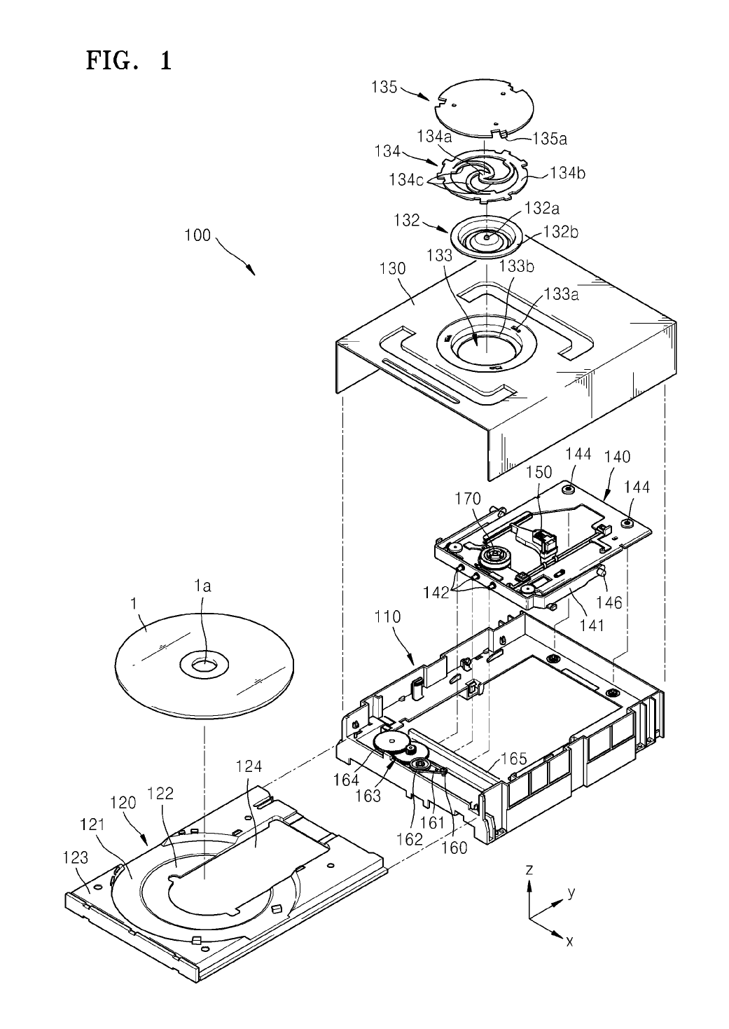

FIG. 1 illustrates an example of a schematic exploded perspective view of an optical disc drive 100. Referring to FIG. 1, the optical disc drive 100 includes a main frame 110, a tray 120 configured to move into and out of the main frame 110, and a cover 130 that covers the main frame 110 so as not to expose the inside of the main frame 110.

In this example, a main base 140 is provided to the main frame 110 and moves up and down with respect to the main frame 110. The main base 140 includes a spindle unit 170 for mounting and rotating an optical disc 1 and an optical pickup unit 150 for irradiating light on the optical disc 150 and for recording information on and/or reproducing the recorded information from the optical disc 1.

For example, the cover 130 includes a clamper 132 that is used in constructing a chucking unit for chucking the optical disc 1 together with the spindle unit 170.

The tray 120 is loaded on and unloaded from the main frame 110. The tray 120 is loaded by sliding into the main frame 110. The tray 120 is unloaded from the main frame 110 by sliding out of the main frame 110 so that the optical disc 1 having a center hole 1a can be retrieved from or mounted on the tray 120. The tray 120 includes an open window 124 for providing a space where the optical pickup unit 150 operates. The tray 120 may also include a first mounting surface 121 and a second mounting surface 122 for mounting two types of discs having different sizes. For example, the first and second mounting surfaces 121 and 122 may be provided for a disc having a diameter of 12 cm and a disc having a diameter of 8 cm, respectively. The first mounting surface 121 may be recessed in a top surface 123 of the tray 120, and the second mounting surface 122 may be recessed in the first mounting surface 121

[Structure Facilitating Moving Up and Down the Main Base 140]

A structure facilitating the moving up and down of the main base 140 will now be briefly described.

Referring to FIG. 1, the main base 140 is coupled to the main frame 110 so as to rotatably move up and down along a rotational axis 146. In one embodiment, a sub base 141 having the rotational axis 146 installed thereon is combined with the main base 140. Fixing holes 144 are disposed on a rear end of the main base 140. The main base 140 is coupled to the main frame 110 through the fixing holes 144 by using an engaging member such as a screw so that the main base 140 may elastically and flexibly rotate. For this purpose, an elastic rubber spacer (not shown) may be interposed between the main base 140 and the main frame 110. A main slider 165 is located at a front end of the main base 140 and reciprocates in synchronization with the movement of the tray 120. A power delivery system causing movements of the tray 120 and the main slider 165 may include a primary driving pulley 160 rotated by a driving motor (not shown), a secondary driving pulley 162 connected to the primary driving pulley 160 by a rubber belt 161, a main gear 163 connected to gear teeth (not shown) of the secondary driving pulley 162, and a tray driving gear 164 meshing with the main gear 163. The tray driving gear 164 is connected to a first rack gear (not shown) disposed on a side of the tray 120 so as to drive the tray 120 in a reciprocating manner and load/unload the tray on/from the main frame 110. A first cam trajectory (not shown) is provided at a bottom surface of the tray 120 and is connected to the main slider 165 so that the main slider 165 may reciprocate in a transverse direction, e.g., a direction intersecting a direction in which the tray 120 is loaded/unloaded during loading/unloading of the tray 120. A second cam trajectory (not shown) is provided in the main slider 165 so as to rotatably move the main base 140 up or down. A plurality of guide pins 142 are located in a middle portion of the sub base 141 and inserted into the second cam trajectory in the main slider 165. A second rack gear (not shown) is disposed on the main slider 165 and is connected with the main gear 163.

When the tray 120 having the optical disc 1 mounted thereon starts to be loaded, the main slider 165 remains unmoved until the main base 140 starts moving from a lowered position. As the loading process continues, the tray driving gear 164 becomes separated from the first rack gear provided on the tray 120. At the same time, the first cam trajectory slightly moves the main slider 165 up from the lowered position so that the second rack gear disposed on the main slider 165 is connected with the main gear 163. The tray 120 stops at a loading end position, so that the spindle unit 170 of the main base 140 is aligned with the center hole 1a of the optical disc 1. In this example, when the driving motor continues to rotate, the tray 120 remains stationary and only the main slider 165 slides in the transverse direction. Then, the main base 140 rotates around the rotational axis 146 due to the second cam trajectory in the main slider 165 so that the spindle unit 170 ascends, thereby placing the optical disc 1 on the spindle unit 170. After the ascending operation of the spindle unit 170 is completed, the optical disc 1 is chucked by the spindle unit 170 and the clamper 132.

When the tray 120 is unloaded, a reverse operation of the above operation is performed. More specifically, as the main slider 165 slides in an opposite direction by the driving motor, the main base 140 rotatably moves downward, and the optical disc 1 is unchucked so that it rests on the tray 120. In this case, the tray 120 remains unmoved. When a descending operation of the main base 140 is almost completed, the tray 120 is slightly unloaded by the main slider 165 so as to connect the tray driving gear 164 to the first rack gear provided on the tray 120 and to disconnect the second rack gear on the main slider 165 from the main gear 163. The driving motor continues to rotate until the tray 120 slides out of the main frame 110 and therefore unloading of the tray 120 is completed.

[Chucking Structure]

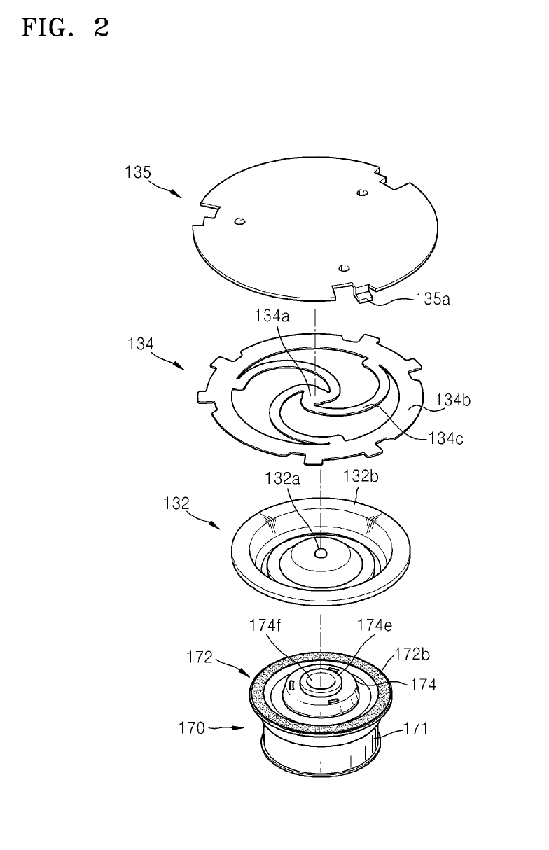

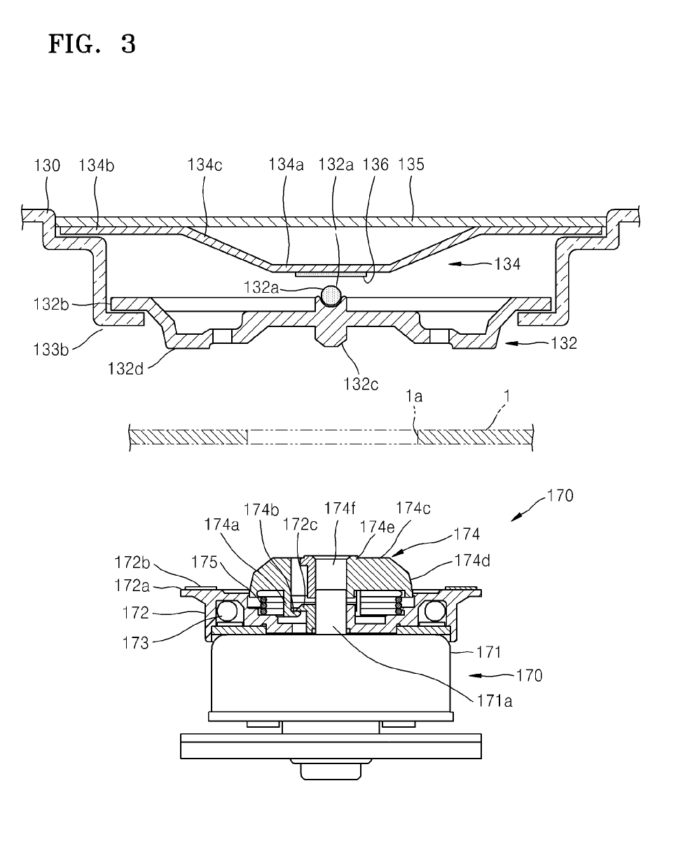

An example of a structure for chucking the optical disc 1 will now be described in detail. FIG. 2 is a diagram illustrating an example of an exploded perspective view of a chucking structure. FIG. 3 is a diagram illustrating an example of a cross-sectional view of the chucking structure of FIG. 2.

Referring to FIGS. 1 through 3, the cover 130 includes an opening 133 surrounded by an annular skirt portion 133b and a clamper 132 that fixes an optical disc 1 to a turntable 172. For example, the clamper 132 includes a ball-type rotation support 132a that is disposed at a center of a top surface 132a of the clamper 132 and that is located to be pressed by a pressing portion 134a of a chucking spring 134, an annular flange 132b corresponding to the annular skirt portion 133b, and an insert protrusion 132c disposed to be inserted into a concave portion 174f in a sliding cone 174. A lubricant may be applied between the ball-type rotation support 132a and the clamper 132. The clamper 132 has a supporting surface 132d that supports a top surface of the optical disc 1. The clamper 132 is inserted into the opening 133 of the cover 130, and the chucking spring 134 is disposed on the clamper 132 to elastically bias the clamper 132. A cap 135 is provided on the chucking spring 134 to close the opening 133. The chucking spring 134 is a leaf spring including the pressing portion 134a that presses the center of the top surface of the clamper 132, a rim 134b fixed on a perimeter of the opening 133, and a plurality of elastic portions 134c interposed between the pressing portion 134a and the rim 134b. The plurality of elastic portions 134c provide an elastic force for pressing the ball-type rotation support 132a. The pressing portion 134a may be coated with lubricant which may reduce friction with the ball-type rotation support 132a. Alternative or in addition to the lubricant coating, the pressing portion 134a may includes a lubricating member 136 attached thereto. As a result, the ball-type rotation support 132a rubs against the lubricating member 136 without direct contact with the pressing portion 134a. This may facilitate smooth rotation of the clamper 143 because the lubricating member 136 is formed of a smooth material that can reduce friction and. A plurality of fixing holes 133a are formed around an outer perimeter of the opening 130, and a plurality of ‘L’ shape fixing jaws 135a protrude around the cap 135 and are hooked by the corresponding plurality of fixing holes 133a, respectively.

Referring to FIGS. 2 and 3, the spindle unit 170 is disposed below the clamper 132 and includes a spindle motor 171 having a rotation shaft 171a and a turntable 172 which is coupled to the rotation shaft 171a and on which the optical disc 1 such as a CD or DVD is seated. A sliding cone 174 is disposed at a center of a top surface 172a of the turntable 172 and is inserted into the center hole 1a of the optical disc 1 (see FIG. 1). A ring-shaped pad 172b is disposed on the top surface 172a of the turntable 172 surrounding the sliding cone 174 so as to provide contacts with a bottom surface of the optical disc 1 around the center hole 1a and thereby to prevent the optical disc 1 from slipping. The turntable 172 may also include ball balancers 173 for reducing rotational vibrations.

The sliding cone 174 may be coupled to the turntable 172 so as to elastically move up and down. The sliding cone 174 includes a hook type guide rod 174a extending down toward the turntable 172 and having a protrusion 174b at its front end. The turntable 172 includes a stopper 172c by which the protrusion 174b of the hook type guide rod 174a is hooked. An elastic member 175 elastically biases the sliding cone 174 upward, i.e., toward the clamper 132. For example, the elastic member 175 may be a compression coil spring interposed between the sliding cone 174 and the turntable 172. The sliding cone 174 includes a top surface 174c disposed opposite the clamper 132 and an oblique outer circumferential surface 174d flaring outward from the top surface 174c and extending obliquely downward. A bump 174e protrudes upward at the top surface 174c of the sliding cone 174, and has a concave portion 174f aligned with the rotation shaft 171a of the spindle motor 171 and recessed downward. For example, the bump 174e protrudes upward at a center of the top surface 174c and the concave portion 174f is concentric with the rotation shaft 171a. The insert protrusion 132c of the clamper 132 described above is fitted into the concave portion 174f during a chucking operation.

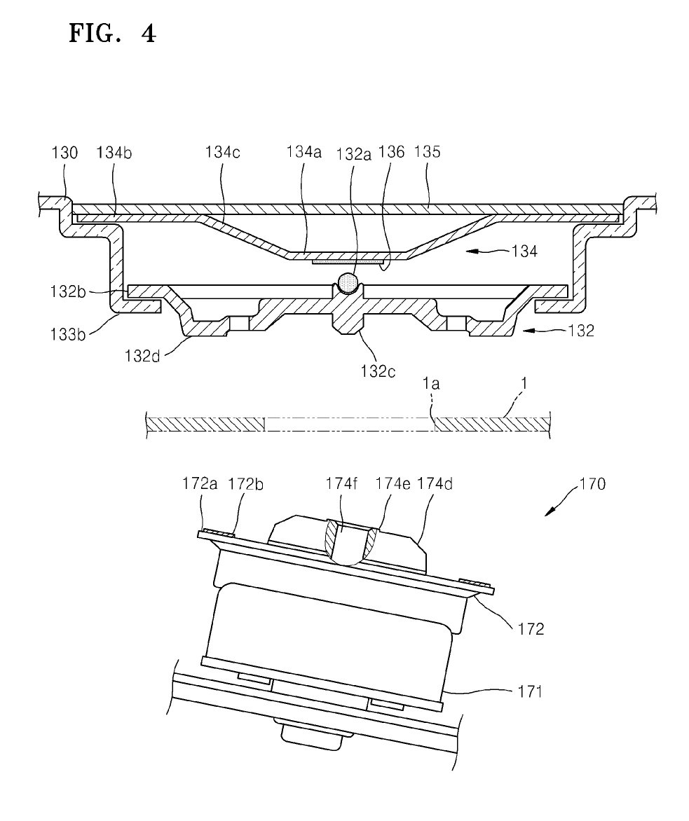

A chucking operation performed by the above-described chucking structure will now be described with reference to FIGS. 4 through 6. FIGS. 4 through 6 illustrate only relationships among the spindle unit 170, the optical disc 1, and the clamper 132, and a description of the main frame 110 and the main base 140 will be omitted here.

FIG. 4 illustrates a state in which the tray is unloaded, i.e., the tray 120 slides out of the main frame 110 in order to mount the optical disc 1. Referring to FIGS. 1 and 4, the main base 140 rotates obliquely downward while the spindle unit 170 is separated from the clamper 132. For example, the clamper 132 may move downward due to a gravitational force until the annular flange 132b is hooked into the skirt portion 133b. In this example, the pressing portion 134a of the chucking spring 134 is separated from the ball-type rotation support 132a thereof. Although not shown in FIG. 4, the clamper 132 may be moved downward by an elastic force of the chucking spring 134 until the annular flange 132 is hooked into the skirt portion 133b. In this state, the optical disc 1 is mounted on the first or second mounting surface 121 or 122 in accordance with a size of the optical disc 1.

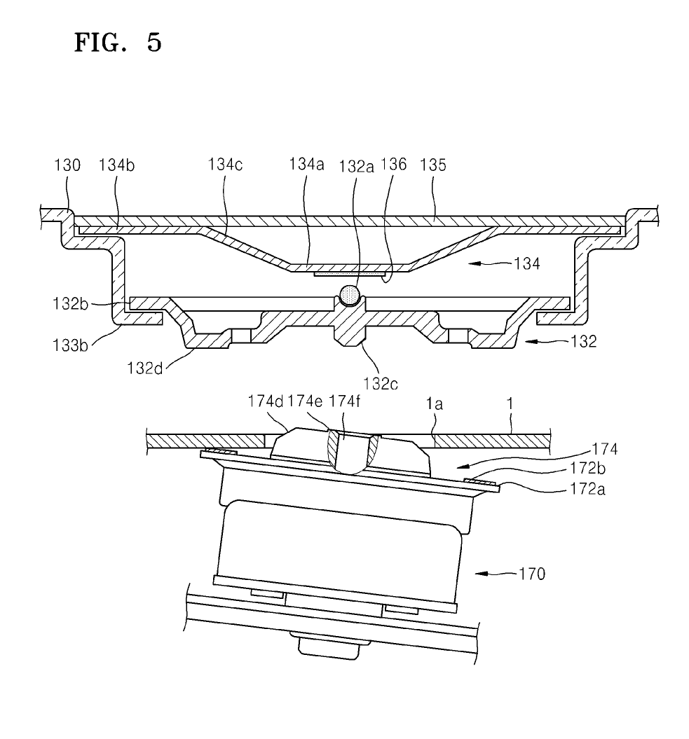

FIG. 5 illustrates a state in which the tray 120 slides into the main frame 110 to some extent. As the tray 120 having the optical disc 1 mounted thereon slides into the main frame 110, the main base 140 gradually rotates upward in the moving structure described above. Then, the spindle unit 170 ascends from below the tray 120 or the optical disc 1 towards the clamper 132, so that the sliding cone 174 is inserted into the center hole 1a of the optical disc 1. Although the spindle unit 170 ascends along a path that is oblique with respect to the optical disc 1, the sliding cone 174 may be easily inserted into the center hole 1a of the optical disc 1 due to the oblique outer circumferential surface 174d. As the spindle unit 170 ascends, a bottom surface of the optical disc 1 is supported by the ring-shaped pad 172b disposed on the top surface 172a of the turntable 172.

Still referring to FIG. 5, as the spindle unit 170 ascends towards the clamper 132, the optical disc 1 is separated from the first or second mounting surface 121 or 122 and approaches the clamper 132. The spindle unit 170 continuously ascends so that the insert protrusion 132c is inserted into the concave portion 174f of the sliding cone 174. As a result, the clamper 132 and the rotation shaft 171a of the spindle motor 171 are aligned to each other in a line. As the spindle unit 170 ascends higher, the supporting surface 132d of the clamper 132 becomes in contact with the top surface of the optical disc 1 and then, the spindle unit 170, the optical disc 1, and the clamper 132 move upward together. As the clamper 132 keeps moving upward, the ball-type rotation support 132a starts pushing up the pressing portion 134a of the chucking spring 134. Accordingly, the plurality of elastic portions 134c are deformed and the annular flange 132b of the clamper 132 are separated from the annular skirt portion 133.

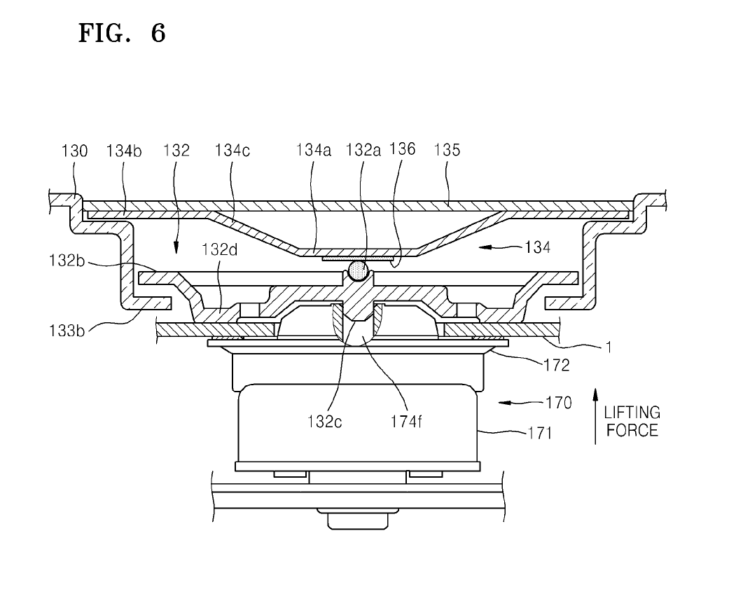

FIG. 6 illustrates a state in which the tray 120 has been completely loaded into the main frame 110. Upon completion of the loading of the tray 120, the bottom surface of the optical disc 1 is supported by the turntable 172 while the top surface thereof is supported by the clamper 132 that is pressed down with a pressure of the chucking spring 134. In this case, the insert protrusion 132c of the clamper 132 is inserted into the concave portion 174f of the sliding cone 174. In addition, the flange 132b of the clamper 132 remains spaced apart from the skirt portion 133b while the ball-type rotation support 132a is supported by the pressing portion 134a of the chucking spring 134. This is a state in which chucking is completed. When the spindle motor 171 rotates in this state, the optical disc 1 rotates while being supported by the turntable 172 and the clamper 132. The presence of the ball-type rotation support 132a reduces rotational friction and allows stable rotation. In this example, the optical disc 1 is specified as an example of a data storage device adapted to be mounted on the tray, and therefore, a different type of data storage device, for example, a magnetic disk, may be loaded on the tray 120.

In the optical disc drive including the chucking structure, a magnet and a yoke are not required to form the sliding cone 174 unlike in a conventional magnetic clamping structure. As a result, the structure of the spindle unit 170 may be simplified, and manufacturing costs may be reduced.

Furthermore, contrary to the conventional magnetic clamping structure, wherein the spindle motor 171 has to include a thrust magnet (not shown) that reduces or counterbalances an axial force which is caused by a lifting force occurring during high-speed rotation of the spindle motor 171 and is exerted on a rotor (not shown) of the spindle motor 171 for the purpose of moving the rotor toward the turntable 172, this example may reduce or counterbalance the lifting force even without having a thrust magnet because the chucking spring 134 presses the turntable 172 in a direction that is opposite to a direction of the lifting force. Thus, the chucking structure, not requiring a thrust magnet, lowers manufacturing costs. Although the above example describes a chucking structure without having a thrust magnet, a thrust magnet may be added to the chucking structure in another example.

In addition to the benefit of reducing manufacturing costs, this example may prevent impact noise caused by a collision of the sliding cone 174 against the clamper 132 for chucking because a chucking force of this example is generated by the chucking spring 134 that smoothly presses the clamper 132 on the spindle 143, not by magnetic force. In other words, because the optical disc 1 and the turntable 172 spontaneously push up the clamper 132 as the spindle unit 170 ascends, impact noise does not occur. In addition, because the chucking spring 134 elastically biases the clamper 132 toward the turntable 172, the clamper 132 applies an appropriate pressure to the optical disc 1 to firmly fix the optical disc on the turntable 172. That is, when the clamper 132 applies a load to the turntable 172 in a direction from top to bottom of the spindle unit 170 to chuck the optical disc 1 on the turntable 172, the clamper 132 presses the optical disc 1, and at the same time, the sliding cone 174 is inserted into the center hole 1a due to appropriate elasticity provided by the elastic member 175 and keeps a concentric arrangement between the optical disc 1 and the spindle motor 171. Thus, the optical disc 1 may be stably rotated during high-speed rotation without vibration.

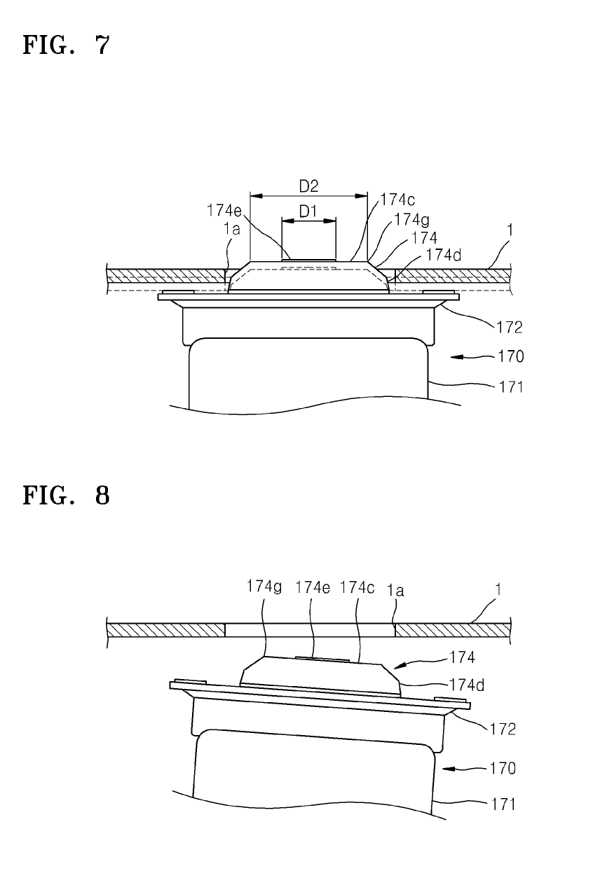

In the spindle unit 170, the sliding cone 174 includes the bump 174e having the concave portion 174f at a center thereof. Referring to FIG. 7, the oblique outer circumferential surface 174d of the sliding cone 174 has a diameter that is less than that of the center hole 1a of the optical disc 1. However, the diameter of the oblique outer circumferential surface 174d may be greater than or less than a specified diameter thereof due to dimensional tolerance. The diameter of the center hole 1a of the optical disc 1 may also be greater than or less than a specified diameter within a tolerance range. In particular, since the optical disc 1 is made by various manufacturers, the diameter of the center hole 1a has a significantly large error range. When the diameter of the oblique outer circumferential surface 174d is greater than the specified diameter thereof, and the diameter of the center hole 1a of the optical disc 1 is less than the specified diameter thereof, a rim of the center hole 1a may be hindered by the oblique outer circumferential surface 174d before the optical disc 1 is seated on the turntable 170. In this state, when the spindle unit 170 continues to move up, the supporting surface 132d of the clamper 132 comes into contact with the top surface of the optical disc 1, the clamper 132 presses down the spindle unit 170, and thus the sliding cone 174 is pushed down as indicated by a dotted line in FIG. 7 despite the presence of elastic forces applied by the elastic member 175. After completing ascending of the spindle unit 170, the insert protrusion 132c may not be sufficiently inserted into the concave portion 174f and thereby may cause a misalignment between the clamper 132 and the rotation shaft 171a. If the optical disc 1 is not stably supported by the turntable 172 and the clamper 132, rotation stability may be degraded, and at worst, the optical disc 1 may escape from the turntable 172 and cause a chucking failure. These problems may occur more often when the optical disc 1 is thicker than a specified thickness, and when a thick optical disc 1, e.g., a 1.5 t disc, is used.

To solve the above problems, a diameter of the oblique outer circumferential surface 174d may be made sufficiently small. However, the insert protrusion 132c of the clamper 132c may still be misaligned with the concave portion 174f of the sliding cone 174 when the spindle unit 170 ascends because the center hole 1a of the optical disc 1 has a large range of variations in position during a chucking operation.

Accordingly, as an embodiment of the present invention, the sliding cone 174 includes the bump 174e projecting upward on the top surface 174c thereof and the concave portion 174f formed at the center of the bump 174e. In this case, even if the sliding cone 174 is pushed down for the above-described reasons, the insert protrusion 132c may remain inserted into the concave portion 174f due to a sufficient depth of the concave portion 174f, thereby allowing a stable chucking operation.

The bump 174e may have a diameter D1 less than a diameter D2 of the top surface 174c of the sliding cone 174. Because the second mounting surface 122 for the optical disc 1 having a diameter of 8 cm is recessed downward from the first mounting surface 121, a distance between the optical disc 1 that is 8 cm in diameter and the sliding cone 174 is less than a distance between the optical disc 1 that is 12 cm in diameter and the sliding cone 174. Therefore, when the spindle unit 170 ascends during loading of the tray 120, an edge 174g of the top surface 174c of the sliding cone 174 may interfere with a bottom surface of the tray 120 or of the optical disc 1 mounted on the second mounting surface 122 if the entire top surface 174c of the sliding cone 174 protrudes upward. The interference may damage the sliding cone 174 and the optical disc 1. Furthermore, the interference with the sliding cone 174 may cause the optical disc 1 to detach from the second mounting surface 122, thereby resulting in a chucking failure. Referring to FIG. 8, interference between the sliding cone 174 and the bottom surface of the tray 120 or of the optical disc 1 may be prevented by making the diameter D1 of the bump 174e less than the diameter D2 of the top surface 174c of the sliding cone 174. In addition, while avoiding the risk of interference, the extent to which the bump 174e protrudes from the top surface 174c of the sliding cone 174 may be increased so as to stably increase the extent to which the insert protrusion 132c of the clamper 132 is inserted into the concave portion 174f.

For example, the extent to which the bump 174e protrudes from the top surface 174c of the sliding cone 174 may be 0.1 mm or more. Alternatively, the extent may be about 0.5 mm or more in order to stably chuck a 1.5 t disc. For example, a minimum distance between an edge of the bump 174e and the bottom surface of the optical disc 1 may be determined as about 0.3 mm or more.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A spindle unit comprising:
a spindle motor having a rotation shaft;
a turntable that is coupled to the rotation shaft and supports a disc; and
a sliding cone that is coupled to the turntable so as to elastically move up and down and is inserted into a hole formed at the disc,
wherein the sliding cone includes a bump protruding from a surface thereof, and the bump has a concave portion recessed downward from a center thereof.

2. The spindle unit of claim 1, wherein the concave portion is aligned with the rotation shaft in a line.

3. The spindle unit of claim 1, wherein the bump has a diameter less than that of the surface of the sliding cone.

4. The spindle unit of claim 3, wherein an extent to which the bump protrudes from the surface of the sliding cone is 0.1 mm or more.

5. The spindle unit of claim 4, wherein the extent to which the bump protrudes from the surface of the sliding cone is 0.5 mm or more.

6. The spindle unit of claim 1, wherein the turntable further comprises a ball balancer that reduces vibrations.

7. The spindle unit of claim 1, further comprising:
an elastic member interposed between the sliding cone and the turntable that elastically supports the sliding cone.

8. A chucking structure comprising:
a spindle unit comprising:
a spindle motor having a rotation shaft,
a turntable that is coupled to the rotation shaft and supports a data storage device, and
a sliding cone that is coupled to the turntable so as to elastically move up and down and is inserted into a hole formed at the data storage device, wherein the sliding cone includes a bump protruding from a surface thereof, and the bump has a concave portion recessed downward from a center thereof; and
a clamper that is disposed to face the turntable and elastically support a surface of the data storage device, wherein the clamper comprises an insert protrusion configured to be inserted into the concave portion.

9. The chucking structure of claim 8, wherein the concave portion is aligned with the rotation shaft in a line.

10. The chucking structure of claim 8, wherein the bump has a diameter less than that of the surface of the sliding cone.

11. The chucking structure of claim 8, wherein the turntable further comprises a balancer that reduces vibrations.

12. The chucking structure of claim 8, wherein the spindle unit further comprises an elastic member interposed between the sliding cone and the turntable that elastically supports the sliding cone.

13. The chucking structure of claim 8, further comprising a chucking spring that biases the clamper toward the turntable.

14. An optical disc drive comprising:
a main frame;
a tray that has an optical disc mounted thereon and is loaded/unloaded by sliding into/out of the main frame;
a main base that moves up and down with respect to the main frame in synchronization with the loading/unloading of the tray;
a spindle unit mounted on the main base, the spindle unit comprising:
a spindle motor having a rotation shaft,
a turntable that is coupled to the rotation shaft and supports the optical disc, and
a sliding cone that is coupled to the turntable so as to elastically move up and down and is inserted into a hole formed at the optical disc, wherein the sliding cone includes a bump protruding from a surface thereof, and the bump has a concave portion recessed downward from a center thereof;
an optical pickup unit mounted on the main base and corresponding to the optical disc;
a cover covering an upper part of the main base; and
a clamper disposed in the cover to face the turntable and elastically support a surface of the optical disc, the clamper comprising configured to be inserted into the concave portion.

15. The optical disc drive of claim 14, wherein the spindle unit further comprises an elastic member interposed between the sliding cone and the turntable so as to elastically support the sliding cone.

16. The optical disc drive of claim 14, wherein the tray comprises first and second mounting surfaces on which discs having different sizes are mounted, respectively, and the second mounting surface is recessed downward from the first mounting surface.

17. The optical disc drive of claim 16, wherein an extent to which the bump protrudes from the surface of the sliding cone is determined so that a distance between an edge of the bump and the other surface of the optical disc is 0.3 mm or more.

18. A disc apparatus comprising:
a clamper comprising
an insert protrusion on a surface of the clamper,
a rotational support on another surface of the clamper disposed to be concentric with the insert protrusion; and
a chucking spring that is elastically movable up and down and is adapted to contact the rotational support.

19. The disc apparatus of claim 18, further comprising:
a lubricating member disposed on a surface of the chucking spring and facing the clamper.

20. The disc apparatus of claim 19, wherein centers of the insert protrusion, the rotational support, and the lubricating members are arranged in a line.
